(19) United States
(12) Patent Application Publication
(10) Pub. No.: US 2007/0063112 A1
(43) Pub. Date: Mar. 22, 2007

(54) Collapsible furniture frame method and apparatus

(75) Inventor: Patrick Patterson, Rogersville, AL (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: PFI Group

(21) Appl. No.: 11/229,789

(22) Filed: Sep. 19, 2005

(51) Int. Cl. F16M 11/38

(52) U.S. Cl. 248/188.6; 248/346.3; 297/440.1

(57) ABSTRACT

A collapsible furniture frame comprises a plurality of elongated members having a tongue portion on each end. A key device has a first portion coupled to a surface of the elongated member near its end. The key device has a second portion configured according to a predetermined shape, such as a cylinder. Each elongated member has a pair of key devices. A receiving block may be configured with a pair of grooves for receiving tongue portions for a pair of elongated members. The pair of grooves may be on adjacent sides so that the elongated members create a right angle relationship to each other when coupled to the receiving block. Each receiving block has a pair of key receptors configured to receive the predetermined shape so that the elongated member is in a lockable relationship with the receiving block.

### TECHNICAL FIELD

This disclosure pertains to furniture construction, and in particular, to the manufacture of furniture that utilizes collapsible frames.

### BACKGROUND

Certain furniture is conventionally manufactured by forming an upper section such as in the manufacture of a chair whereby the back, sides, and bottom have assembled wooden internal components, which are then covered in part with resilient foam padding. The padded foam may then be covered with a suitable outer fabric. This upholstered upper section is then inverted and a decorative wooden frame having legs or corner blocks for subsequent leg attachment is attached as with screws, bolts or other fasteners.

Manufacture of furniture in this manner has been proven economical and cost-effective. Upholstered furniture manufacturers bulk purchase attractive decorative frames generally preassembled in rectangular fashion and add legs of their choice.

Such legs generally come with threaded studs for easy assembly into threaded fasteners affixed to the corner blocks of the preassembled frames. Thus by changing the frame, fabrics and leg designs, any of a large variety of particular furniture items such as chairs can be offered to retail stores on a custom basis. Case goods such as dressers also have frames used in the construction thereof.

Preassembled frames may generally be shaped to fit a particular size furniture item. When shipped from long distances, their cost may escalate due to both the weight of the frames and the volume of space occupied. This situation is of particular concern when such frames are transported by ship or airplane, at which time the volume of the shipment may be of concern.

Thus, there is a heretofore unaddressed need to overcome the deficiencies and shortcomings described above.

### BRIEF DESCRIPTION OF THE DRAWINGS

Many aspects of this disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a diagram of a chair as manufactured using a standard preassembled frame.

FIG. 2 illustrates the frame of FIG. 1, as removed from the upholstered chair upper section.

FIG. 3 is a diagram of a top view of the frame shown in FIG. 2.

FIG. 4 is a diagram of the frame of FIG. 3 along lines 4-4 thereof.

FIG. 5 is a diagram of a step in the conventional assembly method utilizing the assembled frame of FIGS. 2 and 3.

FIG. 6 is a diagram of a top view of a preferred embodiment of the frame for use with the chair upper section of FIG. 1 configured in a tongue-and-groove implementation.

FIG. 7 is a perspective view diagram of the frame of FIG. 6.

### SUMMARY

A collapsible furniture frame comprises a plurality of elongated members having a tongue portion on each end. A key device has a first portion coupled to a surface of the elongated member near its end. The key device has a second portion configured according to a predetermined shape, such as a cylinder. Each elongated member has a pair of key devices.

A receiving block may be configured with a pair of grooves for receiving tongue portions for a pair of elongated members, or rails. The pair of grooves may be on adjacent sides so that the elongated members create a right angle relationship to each other when coupled to the receiving block. Each receiving block has a pair of key receptors, or slots in one nonlimiting example, configured to receive the predetermined shape (i.e., cylinder) so that the elongated member is in a lockable relationship with the receiving block.

In an alternate embodiment, the collapsible furniture frame may have at least four elongated rail members such that each has a male coupling on either end. A pair of locking glides may be coupled to each elongated rail member such that a locking glide is positioned on an end of the rail member. The locking glide may have a first portion configured to receive a coupling device, such as a screw, for attaching the locking glide to the rail member. The locking glide may have a second portion of a predetermined shape, such as a cylinder. The frame may include at least four coupling blocks. Each coupling block may have a pair of female coupling configurations that receive a male coupling configuration of a rail member and the second portion of a locking glide coupled to the rail member. Thus, the frame may be securely fastened in a tongue-and-groove configuration as well as locked together by the second portion received by the coupling, or corner, block.

The frame may be assembled or disassembled as desired by coupling or decoupling the rail members from the coupling blocks according to the tongue-and-groove configuration as well as the locking glide, as received by the coupling block. Upon being assembled, the frame may be coupled to an upholstery section of an article of furniture.

### DETAILED DESCRIPTION

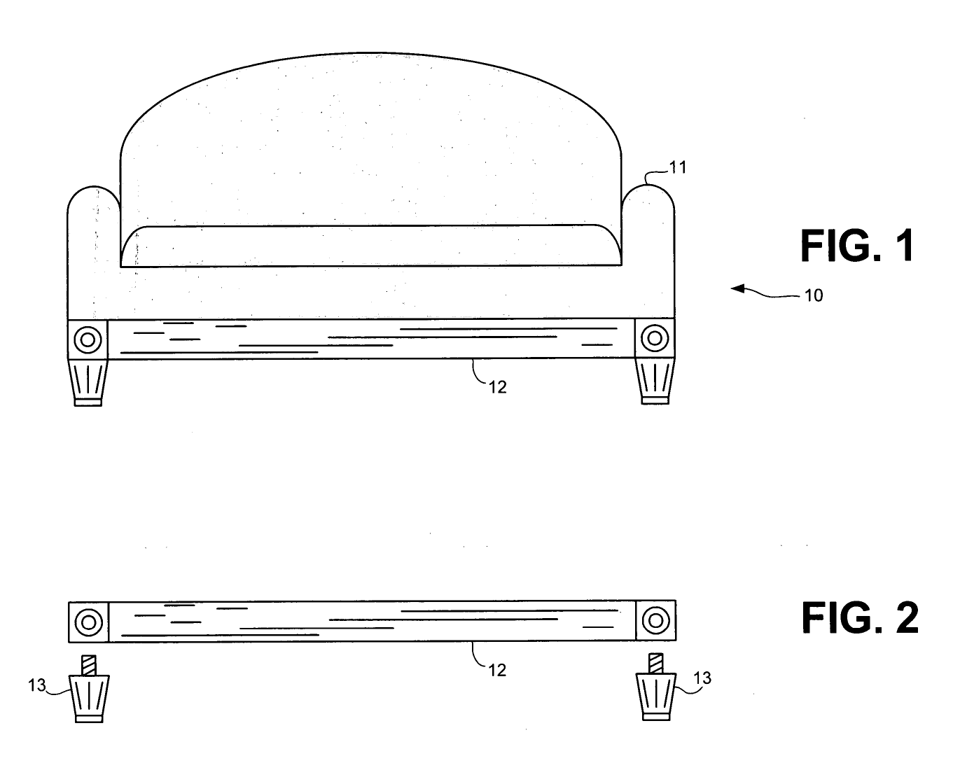

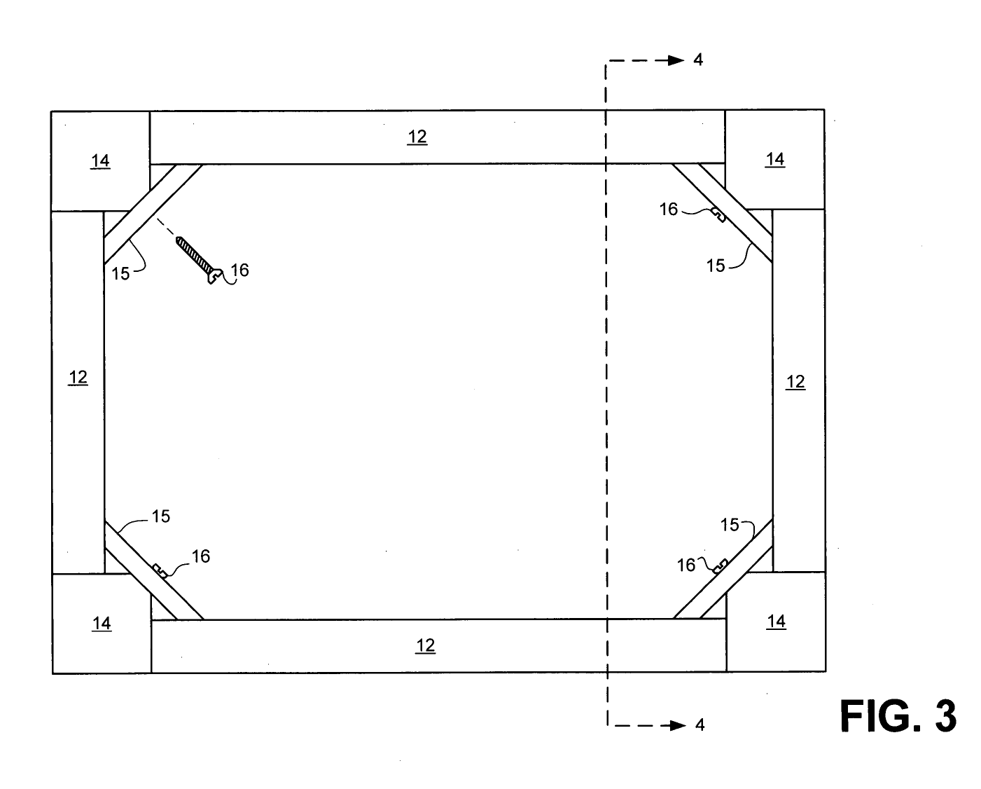

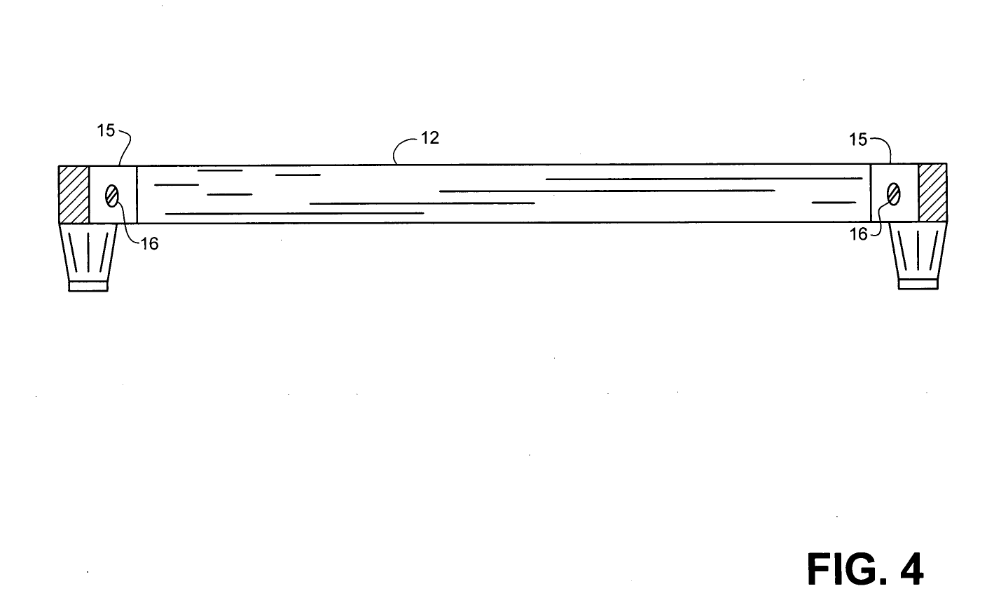

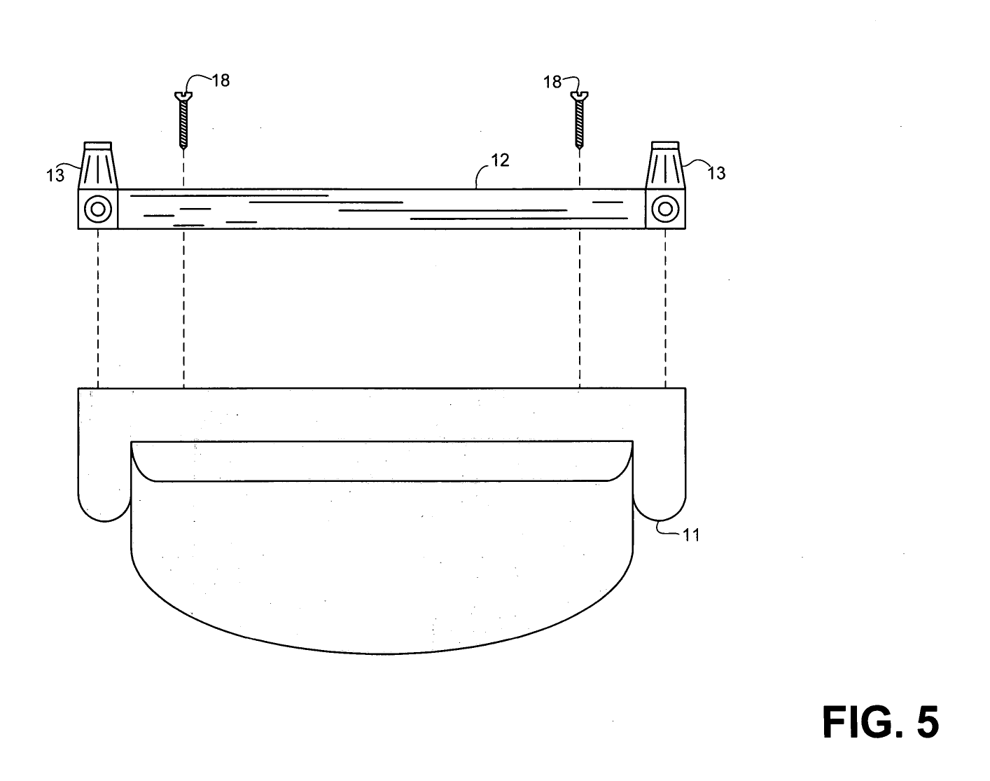

FIGS. 1-5 illustrate an upholstered furniture article 10, including its frame 12 and methods of assembly. In FIGS. 1-5, finished upholstered chair 10 includes an upper portion 11 with assembled rectangular frame 12 joined thereto. Frame 12, as shown in FIG. 2, may generally be shipped, and legs 13, having threaded studs, may be assembled at a chair manufacturing plant. Frame 12, as seen in FIGS. 3 and 4, consists of front, back and side rails, which are joined with corner blocks 14. Braces 15, which are attached by threaded members 16, further stabilize frame 12. Standard frame 12 may be assembled and shipped in rectangular form, as shown in FIG. 3.

As frame 12 may be formed of decorative wood or other dense materials, shipping costs are expensive both because of the weight and of the volume. During assembly, upper upholstered chair portion 11 may be inverted during assembly, as shown in FIG. 5, and frame 12 having legs 13 previously attached is then affixed to upper portions 11 such as by screws 18, bolts, adhesives (not seen) or other fasteners.

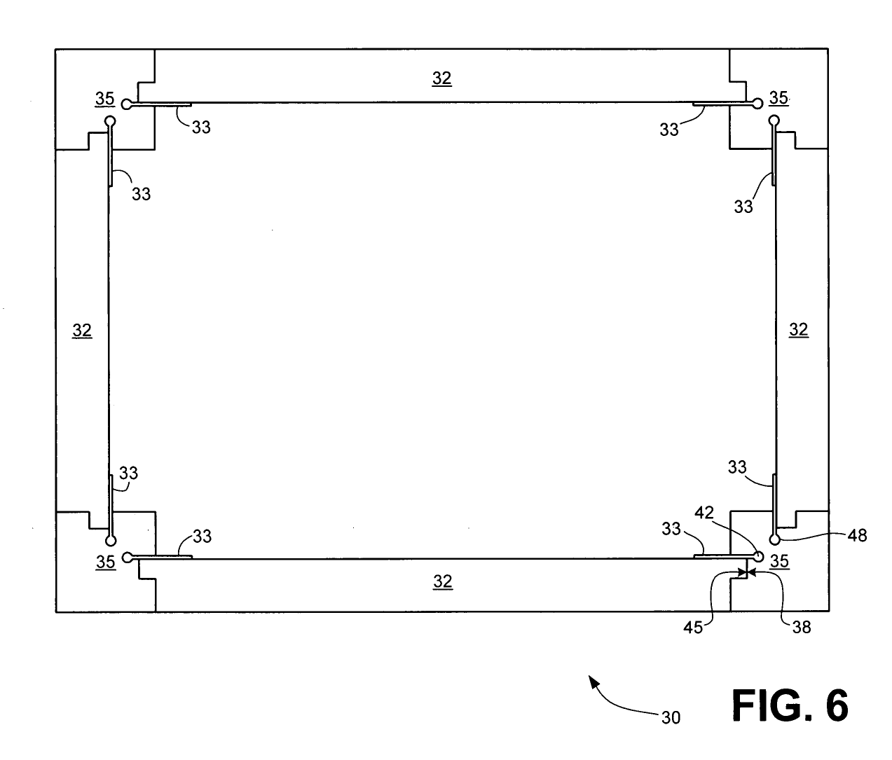

FIG. 6 is a top view diagram of a preferred embodiment of frame 30, which may be coupled to the upholstery 11 of FIG. 1. In this nonlimiting example, rails 32 may be coupled to corner blocks 35 via a tongue-and-groove implementation, as shown in FIG. 6. More specifically, rails 32 may include a tongue section 45 that matches to a groove section 38 on corner block 35.

Furthermore, a key portion 33 may be configured to lock into a receiving groove 48 in corner block 35. Key portion 33 may include cylinder portion 42 that may slide into a receiving groove 48 on corner block 35. When inserted, the rail 32, which is attached to the key portion 33, becomes securely locked in place with the corner block 35. One of ordinary skill would know, however, that cylinders 42 could be any other shape, such as a square, triangle, etc. Likewise, opening 48 could also be sized accordingly to receive the key portion 33.

Key portion 33 may be coupled to a rail 32 by any means known in the art. In one nonlimiting example, screws 52 may fasten the plate portion of key portion 33 to a facing of a rail 32 to as to establish the tongue portion of the tongue-and-groove assembly described herein.

Each of corner blocks 35 of the frame 30 in FIG. 6 may be so configured with this tongue-and-groove implementation and receiving groove 48 so that rails 32 may be slidably coupled into the grooves of corner block 35 to create the frame 30 of FIG. 6. However, for shipping purposes, one or more of the rails 32 and/or corner blocks 35 may be disassembled from the configuration 30 shown in FIG. 6 so as to reduce the size and volume of the chair 10 of FIG. 1 having a frame 30 of FIG. 6.

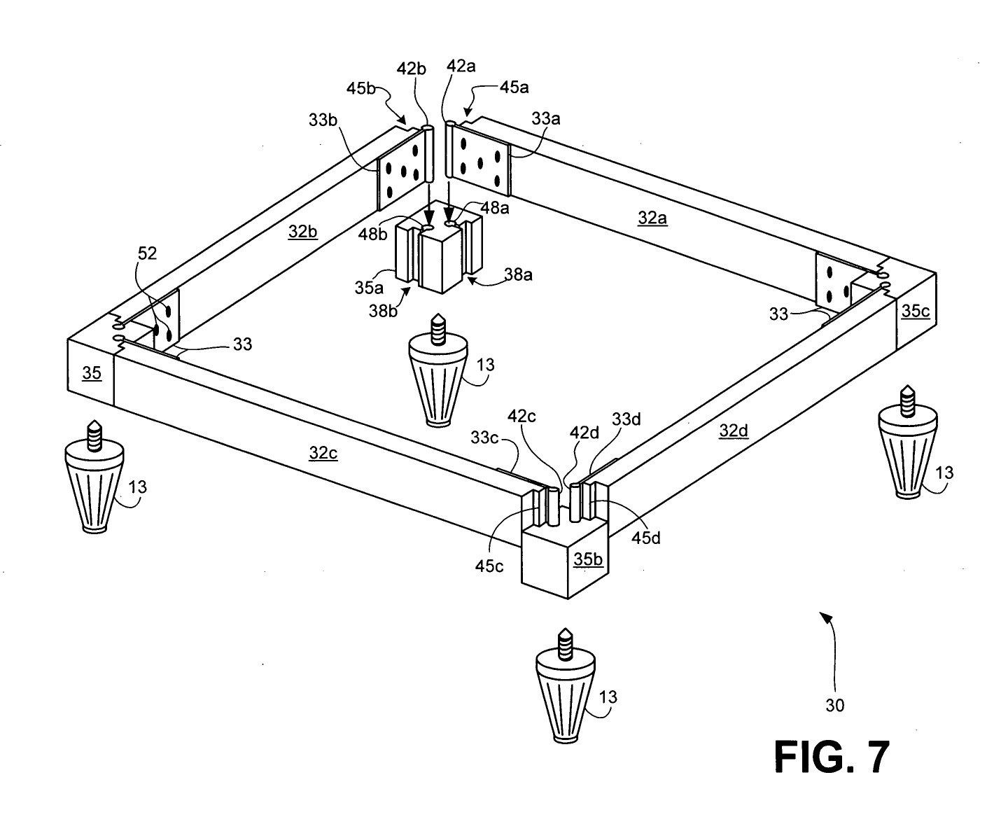

FIG. 7 is a perspective view diagram of the frame 30 of FIG. 6. In this diagram, each of corner blocks 35 are shown either coupled partially, coupled completely, or merely separated from rails 32. This partial coupling, as a nonlimiting example, of corner block 35b from rails 32c and 32d depicts how the rails 32 slide into a locking relationship with the corner blocks 35.

In this nonlimiting example of FIG. 7, rails 32a and 32b are shown in a configuration wherein corner block 35a may be installed to join the two rail sections together. More specifically, tongue portion 45a on rail 32a may be received by groove 38a on corner block 35a. Likewise, cylinder 42a of key portion 33a may be slidably coupled into receiving groove 48a so as to lockably couple rail 32a to corner block 35a.

The same operation may take place in regard to corner block 35a and rail 32b. More specifically, tongue portion 45b may be received by groove 38b. Cylinder 42b of key portion 33b may be slidably coupled into receiving groove 48b. In coupling rails 32a and 32b to corner block 35a in this manner, a sturdy and secure frame may be created. However, for purposes of transportation so as to reduce volume and shipping weight, each of corner blocks 35 may be separated from rails 32 so as to collapse frame 30 during transportation.

This slidably locking relationship between rails 32 and corner blocks 35 is depicted in FIG. 7 between rails 32c and 32d, as coupled to corner block 35b. In this nonlimiting example of FIG. 7, each of rails 32c and 32d are shown partially coupled to corner block 35b such that the tongue portions 45c and 45d of rails 32c and 32b, respectively, as well as the cylinders 42c and 42d and key portions 33c and 33d, respectively, of each of rails 32c and 32d, are exposed. Once fully coupled, the physical relationship between the rails 32 and corner block 35 may be depicted as shown with rails 32a and 32d with corner block 35c.

Once all rails 32 and corner blocks 35 are coupled, the frame 30 is sturdy and stable. One of ordinary skill in the art would know that legs 13 may thereafter be coupled to corner blocks 35, as also shown in FIG. 2, so that frame 30 may be coupled to upholstery 11 of FIG. 1.

It should be emphasized that the above-described embodiments and nonlimiting examples are merely possible examples of implementations, merely set forth for a clear understanding of the principles disclosed herein. Many variations and modifications may be made to the above-described embodiment(s) and nonlimiting examples without departing substantially from the spirit and principles disclosed herein. All such modifications and variations are intended to be included herein within the scope of this disclosure and protected by the following claims.

I claim:

1. A collapsible furniture frame system, comprising:
a plurality of elongated members each having a tongue portion having a predetermined configuration on each end;
a key having a first portion couplable to a surface of the elongated member near an end of the elongated member and a second portion configured according to a predetermined shape; and
a receiving block configured with a pair of grooves for receiving tongue portions for a pair of elongated members and for a pair of key receptors configured to receive the second portion of the key.

2. The system of claim 1, wherein four elongated members are coupled to four receiving blocks such that the receiving blocks are positioned at ends of the four elongated members and establish corners of the frame.

3. The system of claim 1, wherein the tongue portion of an elongated member and a second portion of the key coupled to the elongated member slidably couple to the groove and key receptor of a receiving block.

4. The system of claim 1, further comprising:
a leg receptor configured on a side of each receiving block to receive a leg having a male coupling device.

5. The system of claim 4, wherein the leg receptor is threaded to receive a male coupling device that has threads so that the leg may be fastened to a side of the receiving block.

6. The system of claim 1, further comprising:
one or more holes configured in the first portion of the key for receiving one or more fasteners for coupling the first portion of the key to a surface of the elongated member.

7. The system of claim 1, wherein the mating of the tongue portion of an elongated member and the second portion of the key to the groove and key receptor of the receiving block establishes a physical relation ship between the receiving block and the elongated member such that the elongated member cannot separate from the receiving block without moving the tongue portion of the elongated member along the length of the groove and the second portion of the key along the length of the key receptor.

8. The system of claim 1, wherein the frame is coupled to an upholstery component.

9. A method for collapsing a furniture frame, comprising the steps of:
establishing a first portion of a tongue-and-groove coupling on each end of a plurality of rail members;
coupling a key device on each end of the plurality of rail members, the key devices having a first portion that is coupled to a surface of the rail member and a second portion of a predetermined shape positioned beyond the endpoint of the rail member; and
establishing a plurality of corner blocks each configured with a pair of second portions of the tongue-and-groove coupling for receiving the first portion of the tongue-and-groove coupling of a pair of rail members and a pair of key receptors for coupling to the predetermined shape of the second portion of the key device on the rail member.

10. The method of claim 9, wherein each corner block couples to two rail members according to the tongue and groove coupling and the coupling of the predetermined shape of the second portion and the key receptor.

11. The method of claim 9, wherein the first portion of the tongue-and-groove coupling on each rail member is a male component, and wherein the second portion of the tongue-and-groove coupling on each corner block is a female component that receives the male component.

12. The method of claim 11, where the second portion of the key device coupled to each end of each rail member is a male component that is received by a key receptor on a corner block that is a female component.

13. The method of claim 11, further comprising the step of:
fastening a leg member to a bottom side of each corner block.

14. The method of claim 11, further comprising the step of:
coupling the furniture frame to an upholstery component.

15. A collapsible furniture frame, comprising:
at least four rail members each having a male coupling configuration on each end;
a pair of locking glides coupled to each rail member such that a locking glide is positioned on an end of the rail member, the locking glide having a first portion configured to receive a coupling device for attaching the locking glide to the rail member and a second portion of a predetermined shape; and
at least four coupling blocks each having a pair of female coupling configurations that receive a male coupling configuration of a rail member and the second portion of a locking glide coupled to the rail member.

16. The frame of claim 15, wherein each coupling block is coupled to two rail members.

17. The frame of claim 15, wherein the predetermined shape of the second portion is a cylinder.

18. The frame of claim 15, wherein the locking glide and the male component create a locking relationship with the female component of a coupling block when slid into an opening on a side of the coupling block.

19. The frame of claim 15, wherein the frame is coupled to an upholstery component.
